(19) United States
(12) Patent Application Publication
(10) Pub. No.: US 2023/0060302 A1
(43) Pub. Date: Mar. 2, 2023

(54) MULTILAYER FLEXIBLE TUBE AND PROCESS FOR THE SAME

(71) Applicant: Mercury Plastics LLC, Middlefield, OH (US)

(72) Inventors: Scott Raymond Gardner, Chagrin Falls, OH (US); Karlton L. Wolf, Chardon, OH (US)

(21) Appl. No.: 16/677,127

(22) Filed: Nov. 7, 2019

Related U.S. Application Data
(60) Provisional application No. 62/756,774, filed on Nov. 7, 2018.

(51) Int. Cl. F16L 11/04; B32B 27/32; B32B 27/08; B32B 27/40; B32B 27/30; B32B 25/16; B32B 25/08; B29C 48/10; B29C 48/21; B29C 48/00; B29C 45/14

(52) U.S. Cl. CPC F16L 11/04; B32B 27/32; B32B 27/08; B32B 27/40; B32B 27/306; B32B 25/16; B32B 25/08; B29C 48/10; B29C 48/21; B29C 48/022; B29C 45/14336; B32B 2597/00; B32B 2250/02; B29K 2023/065

(57) ABSTRACT

This invention relates in general to a multilayer tube and methods of making the same. In particular, this invention relates to a multilayer tube used as a riser, such as those that may be connected to shutoff or “stop” valve on one end and a plumbing hook-up to the other end. The multilayer tube comprises a first inner polymer layer and a second outer polymer layer, wherein the first and second polymer layers are not substantially bonded to each other. To facilitate use, the tube may additionally comprise one or more overmolded components, such as pipe connectors, plumbing connections, plumbing fittings, valve connectors and appliance connectors. The layers are not substantially bonded.

### CROSS-REFERENCE TO RELATED APPLICATIONS

This application claims priority to, and the benefit of, U.S. Provisional Application No. 62/756,774 filed on Nov. 7, 2018 with the United States Patent Office, which is hereby incorporated by reference.

### TECHNICAL FIELD

This invention relates in general to a multilayer flexible tube or hose. In particular, this invention relates to a multilayer flexible tube or hose used as a riser, such as those that may be connected to shutoff or “stop” valve on one end and a plumbing hook-up to the other end.

### BACKGROUND

Risers are typically attached to a shutoff or “stop” valve on one end and a faucet or toilet fill valve on the other. Risers were traditionally made from metal pipe, including copper, steel, or lead. Plastic risers have been attempted. However, the plastic rises currently used are quite rigid, and not able to be bent in different directions due to kinking, which damages the riser and may even result in failure. Therefore, the path that the riser follows from the shutoff valve to the faucet or toilet fill valve must be relatively straight and free of bends. Additionally, this straight path may be obstructed due to other structures in the area, such as a sink waste pipe, making any such straight connection difficult or impossible.

Additionally, metal crimp ring connections, brass inserts, or rubber washers are often used to attach hoses to fittings. Metal crimp rings, brass inserts, and rubber washers introduce additional connections which may be prone to leaking. By example, metal crimp ring connections have points of high and low concentration around the fitting, which results in unequal distribution of force and potential leak points. The use of metal fittings, such as brass inserts, introduces contact with the water in the water way which can lead leaching, corrosion, dezincification, and/or the attack of hard water on brass fittings.

Coextrusion is the process of pressing two or more materials through the same die to produce a single piece. When multiple materials, including plastics, are combined, the result can yield properties distinct from those of a single material. A multilayer tube or tubes may be coextruded whereby multiple layers of material are extruded simultaneously. Alternatively, two or more materials may be extruded by cross-head extrusion, which is known in the art. If the materials are compatible, they will bond together during the extrusion process. If the materials are incompatible, manufactures must find ways to adhere them together to prevent delamination or separation of the multiple layers. Adhering dissimilar materials can be accomplished using various known methods including: using an adhesive, using bonding agents, using a tie layer, heat-shrinking or etching the materials, direct-bonding them, etc.

### SUMMARY

A multilayer flexible tube or riser for connection to faucets and toilet hook-ups is desirable as it would have an advantage over rigid tube risers in that the multilayer flexible tube or riser can be twisted and shaped to accommodate valve connections which are typically offset or where space limitations require such bending.

The multilayer flexible tube or hose disclosed herein is specifically designed to resist attack and degradation from chlorine, cleaning products (particularly chlorine and ammonia based) and foaming insulation chemicals.

The multilayer tube comprises a first inner polymer layer and a second outer polymer layer, wherein the first and second polymer layers are not substantially bonded to each other. To facilitate use, the tube may additionally comprise one or more overmolded components, such as pipe connectors, plumbing connections, plumbing fittings, valve connectors and appliance connectors.

The first inner polymer layer and a second outer polymer layer are not substantially bonded to each other. In some embodiments, 150 pound force (lbf) or less, or 100 lbf or less, or 88 lbf or less, or 70 lbf or less, is necessary to separate the inner and outer layers.

In some examples, the inner layer may be a polyethylene, such as a high density polyethylene and/or a cross-linked polyethylene. In addition or in the alternative, the outer layer may be a thermoplastic urethane polymer, an ethylene vinyl acetate polymer, or an ethylene propylene diene terpolymer, for example.

A method of making the multilayer tube comprises extruding a hollow inner polymer layer and an outer polymer layer, wherein the inner polymer layer and the outer polymer layer are not substantially bonded to each other. The layers may be coextruded or extruded by cross-head extrusion, for example. The polymers used for inner and outer may be incompatible with each other such that they do not normally bond to each other, or an antibonding agent may be added to reduce or prevent bonding between the layers.

Various aspects will become apparent to those skilled in the art from the following detailed description and the accompanying drawings.

### BRIEF DESCRIPTION OF THE DRAWINGS

Reference is made to the accompanying drawings in which particular embodiments and further benefits of the invention are illustrated as described in more detail in the description below, in which:

FIG. 1 is a perspective view of a multilayer flexible riser according to an embodiment of the present disclosure.

FIG. 2 is a perspective view of a multilayer flexible tube according to an embodiment of the present disclosure.

FIG. 3 is an end view of the multilayer flexible tube as shown in FIG. 2

FIG. 4 is an exploded view of the multilayer flexible tube as shown in FIG. 2 displaying removal of sections of the outer layer.

FIG. 5 is a perspective view of a multilayer flexible tube according to an embodiment of the present disclosure displaying overmolded components at the tube ends.

FIG. 6 is a perspective cross-sectional view of the multilayer flexible tube of FIG. 5.

FIG. 7 is a cross-sectional view of the multilayer flexible tube of FIG. 5.

FIG. 8 is a cross sectional view of the multilayer flexible tube of FIG. 5 displaying a fitting inserted into one of the tube ends.

### DETAILED DESCRIPTION

The multilayer tube or hose disclosed herein may be used for connecting hot and cold potable water supply lines to faucets or fixtures. Other applications include toilets, washing machines, dishwashers, appliances and any other potable water applications. The multilayer tube or hose needs to be flexible in order to twist and navigate limited space areas, such as beneath a sink, in order to connect from the water supply lines to the faucet, which may not be a direct route. Of course, the present invention is not limited for use with potable water applications, but could be used with other types of fluids and/or applications.

The multilayer tube of the present invention comprises at least two layers: an inner layer and an outer layer. In one embodiment, the inner layer is a hollow cylindrical inner layer. The inner layer provides rigidity and strength for carrying water without bursting under high pressure and high temperature. In one embodiment, the inner layer can withstand 250 psi at 180° F. for 30 minutes. It is appreciated that the inner layer thickness may be any dimension required for a particular application. Example materials for the inner layer may be various types of polymers including polyethylene, high density polyethylene, linear, low density polyethylene, PERT (polyethylene of raised temperature), polypropylene, nylon and semi-rigid PVC. Additionally, these polymers may be crosslinked as discussed herein.

The outer layer is provided around the inner layer (i.e. around an outer peripheral surface of the inner layer). The outer layer is softer and more flexible than the inner layer. The outer layer provides overall flexibility to the hose, which provides deformation resistance and hoop strength. When a hose is bent and the walls of the hose deform such that a portion of the hose collapses at the location of bending pressure a “kink” may be formed in the hose. The less flexible a hose, the greater the possibility kinks form during bending. Kinks lead to damage in the hose which result in restricted flow, potential leaks and shorter overall life. It is appreciated that the outer layer thickness may be any dimension required for a particular application. The outer layer may be thicker than, equal to, or less than the inner layer. Example materials for the outer lay may include ethylene vinyl acetate (EVA), thermoplastic urethane (TPU), ethylene propylene diene terpolymer (EPDM), thermoplastic vulcanizate (TPV), flexible PVC, and other known flexible polymers.

The inner layer and the outer layer are extruded to form the multilayer tube of the present invention. In one example, the inner layer and the outer layer are coextruded. In another example, the multilayer tube is formed by cross-head extrusion. However, in certain embodiments, the multilayer tube is devoid of a bond between the inner layer and the outer layer. Furthermore, in certain embodiments, the multilayer tube is devoid of any tie layer between the inner layer and the outer layer. However, the inner layer should either not bond or substantially not bond to the outer layer during and after coextrusion. In other words, there should be either no adhesion or minimal adhesion between the inner layer and the outer layer. In one embodiment, the inner layer is not bonded to the outer layer and thus there is no adhesion between the two layers. In another embodiment, the inner layer is substantially not bonded to the outer layer meaning there is minimal adhesion between the two layers. In some examples, “substantially not bonded” may mean 20 percent or less of the surface area of contact between the layers is bonded. In other examples, 15 percent or less, 10 percent or less, or even 5 percent or less of the surface area between the layers is bonded. In still other examples, 2 percent or less or even 1 percent or less of the surface area between the layers is bonded.

In order to facilitate no bond or substantially no bond between the outer layer and the inner layer in certain embodiments, incompatible materials may be chosen prior to extrusion to achieve this. Incompatible materials are materials that do not bond or do not substantially bond to each other during extrusion. In one example, the inner layer is polyethylene and the outer later is thermoplastic urethane (TPU). During extrusion, these materials do not bond together such that no bond or substantially no bond forms between the inner layer and outer layer. In an alternative embodiment, and if the materials chosen for the multilayer tube would be compatible and normally bond together during coextrusion, an additional step or steps would be taken to inhibit bonding between the two materials. Examples of such bonding inhibitors include calcium carbonate and corn starch which would prevent bonding during coextrusion. In this example, a non-binding layer is provided between the inner layer and the outer layer during the extrusion process. This non-binding layer may be a powder layer. Additionally or alternatively, a surface treatment of the inner layer and/or outer layer may be utilized to prevent bonding or substantially no bonding between the respective layers. Such a surface treatment may include cooling down the inside wall of the flexible outer layer enough so that a bond is not formed to the PEX inner layer. This may be done by forcing/blowing air through the back of the die during extrusion to cool the inside wall of the flexible outer layer. Alternatively, the inner layer may be crosslinked prior to cross-head extrusion which would prevent bonding or substantially no bonding between the respective layers.

To be substantially not bonded, a section of the outer layer should be removable from the inner layer without tearing of the section of the outer layer after the cutting process of the outer layer as described herein. In other words, the bonding or adhesion between the two materials (i.e. the inner layer and the outer layer) is less than the tensile strength of the outer layer in order for the inner layer and outer layer to be substantially not bonded.

The lack of a substantial bond between the layers may also be expressed as a function of the amount of force necessary to displace a section of an outer layer of the multilayer flexible tube from the inner layer of the multilayer tube without tearing of the section of the outer layer. In some examples, 150 pound force (lbf) or less is necessary to separate the inner and outer layers. In one such example, the force necessary may be 100 lbf or less. In another example, the force necessary may be 70 lbf or less. In other examples, 40-100 lbf is necessary to separate the inner and outer layers. In still other examples, 88 lbf or less is required to separate the inner and outer layers. In yet other examples, between 33 lbf and 88 lbf is required. The lack of a bond or adhesion between the inner layer and the outer layer improves the flexibility of the multilayer tube by allowing the layers to be displaced relative to each other, thereby distributing stresses associated with bending over a wider area rather than localizing those stresses in one particular area.

The quantification of the amount of force necessary to separate the inner and outer layers may be shown with the following examples. For the multilayer tube testing, an inner layer of polyethylene (PE) and an outer layer of ethylene vinyl acetate (EVA) were used. Since PE and EVA typically bond together during extrusion, a bonding inhibitor was added between the PE inner layer and the EVA outer layer so these respective layers would be substantially not bonded. The bonding inhibitors comprised corn starch and calcium carbonate as set forth in the tables below. The PE inner layer was pre-extruded or extruded first. The PE layer was then run through a trough of the bonding inhibitor to powder the PE layer. The powdered PE layer was then run through the back of a die and the EVA outer layer was added by crosshead extrusion to form the multilayer tube. In one set of tests, a length of multilayer tube according to the claimed invention consisting of an inner layer of PE and an outer layer of EVA was cut to a length of 0.600 inches. A 0.350 inch section of the outer EVA layer (i.e. EVA ring) was then removed, leaving a 0.250 inch section that remained double walled with both the PE layer and the EVA layer, and a 0.350 inch section of only the PE layer. A washer was placed as support under the multilayer tube such that only the outer EVA layer was supported by the washer. Force was applied to the inner PE tube using an Instron tester and the amount of force necessary to displace the section of the outer EVA tube from the inner PE tube was recorded. The amount of force necessary to displace the remaining 0.250 inch section of the EVA layer from the PE layer ranged from 33 lbf to 88 lbf for the 24 samples tested with the average force being 58 lbf as shown in Table 1 below.

TABLE 1
Force (lbf) Necessary to Displace a 0.25″ EVA Ring

| Bonding | | | | | | |
|---|---|---|---|---|---|---|
| Inhibitor | Samples | | | | | Average |
| Corn | 50 | 48 | 48 | 38 | 50 | 47 |
| Starch | | | | | | |
| Corn | 35 | 33 | 45 | 82 | 71 | 53 |
| Starch | | | | | | |
| Calcium | 69 | 57 | 40 | 49 | | 54 |
| Carbonate | | | | | | |
| Calcium | 60 | 75 | 56 | 81 | 65 | 67 |
| Carbonate | | | | | | |
| Calcium | 64 | 62 | 59 | 66 | 88 | 68 |
| Carbonate | | | | | | |

In a second set of tests using the same extrusion process in the first set of tests, a length of multilayer tube according to the claimed invention consisting of an inner layer of polyethylene (PE) and an outer layer of ethylene vinyl acetate (EVA) was cut to a length of 0.800 inches. A 0.300 inch section of the outer EVA layer (i.e. EVA ring) was then removed, leaving a 0.500 inch section that remained double walled with both the PE layer and the EVA layer, and a 0.300 inch section of only the PE layer. The amount of force necessary to displace the remaining 0.500 inch section of the EVA layer from the PE layer ranged from 40 lbf to 100 lbf for the 24 samples tested with the average force being 70 lbf as shown in Table 2 below.

TABLE 2
Force (lbf) Necessary to Displace a 0.50″ EVA Ring

| Bonding | | | | | | |
|---|---|---|---|---|---|---|
| Inhibitor | Samples | | | | | Average |
| Corn | 81 | 68 | 69 | 77 | 76 | 74 |
| Starch | | | | | | |
| Corn | 88 | 100 | 85 | 93 | 80 | 89 |
| Starch | | | | | | |
| Calcium | 48 | 69 | 63 | 64 | 51 | 59 |
| Carbonate | | | | | | |
| Calcium | 72 | 84 | 70 | 68 | 78 | 74 |
| Carbonate | | | | | | |
| Calcium | 62 | 40 | 61 | 44 | | 52 |
| Carbonate | | | | | | |

In a third set of tests using the same extrusion process in the first and second set of tests, a length of multilayer tube according to the claimed invention consisting of an inner layer of polyethylene (PE) and an outer layer of ethylene vinyl acetate (EVA) was cut to a length of 1.300 inches. A 0.550 inch section of the outer EVA layer (i.e. EVA ring) was then removed, leaving a 0.750 inch section that remained double walled with both the PE layer and the EVA layer, and a 0.550 inch section of only the PE layer. The amount of force necessary to displace the remaining 0.750 inch section of the EVA layer from the PE layer ranged from 56 lbf to 98 lbf for the 23 samples tested with the average force being 77 lbf as shown in Table 3 below.

TABLE 3
Force (lbf) Necessary to Displace a 0.75″ EVA Ring

| Bonding | | | | | | |
|---|---|---|---|---|---|---|
| Inhibitor | Samples | | | | | Average |
| Corn | 79 | 75 | 82 | 74 | | 77 |
| Starch | | | | | | |
| Corn | 78 | 76 | 75 | 85 | 88 | 80 |
| Starch | | | | | | |
| Calcium | 68 | 56 | 56 | 66 | 62 | 62 |
| Carbonate | | | | | | |
| Calcium | 98 | 82 | 93 | 86 | 84 | 89 |
| Carbonate | | | | | | |
| Calcium | 79 | 75 | 82 | 74 | | 77 |
| Carbonate | | | | | | |

As used in this application, the term “overmold” means the process of injection molding a second polymer over a first polymer, wherein the first and second polymers may or may not be the same. In one embodiment of the invention, the composition of the overmolded polymer will be such that it will be capable of at least some melt fusion with the composition of the polymeric tube. There are several means by which this may be affected. One of the simplest procedures is to insure that at least a component of the polymeric tube and that of the overmolded polymer is the same. Alternatively, it would be possible to insure that at least a portion of the polymer composition of the polymeric tube and that of the overmolded polymer is sufficiently similar or compatible so as to permit the melt fusion or blending or alloying to occur at least in the interfacial region between the exterior of the polymeric tube and the interior region of the overmolded polymer. Another manner in which to state this would be to indicate that at least a portion of the polymer compositions of the polymeric tube and the overmolded polymer are miscible. In contrast, the chemical composition of the polymers may be relatively incompatible, thereby not resulting in a material-to-material bond after the injection overmolding process. In one example, the inner layer and the overmolded components are both made from polyethylene, and such polyethylene may be high density polyethylene (HDPE). Have this same material allows for melt fusion of the overmolded components onto the inner layer.

The lack of a bond or substantially no bond between the inner layer and outer layer is necessary in order to allow for removal of a section of the outer layer to expose a section of the inner layer for subsequent overmolding of an overmolded component. The overmolded components may be pipe connectors, plumbing connections, plumbing fittings, valve connectors or appliance connectors, but are not limited to any particular type or shape of fitting or connector. As noted above, the lack of a bond also improves the flexibility of the multilayer tube. The overmolding can occur at either end of the multilayer tube, both ends of the tube, or at a non-end position or positions, i.e., at any location between the ends or at multiple locations between the ends.

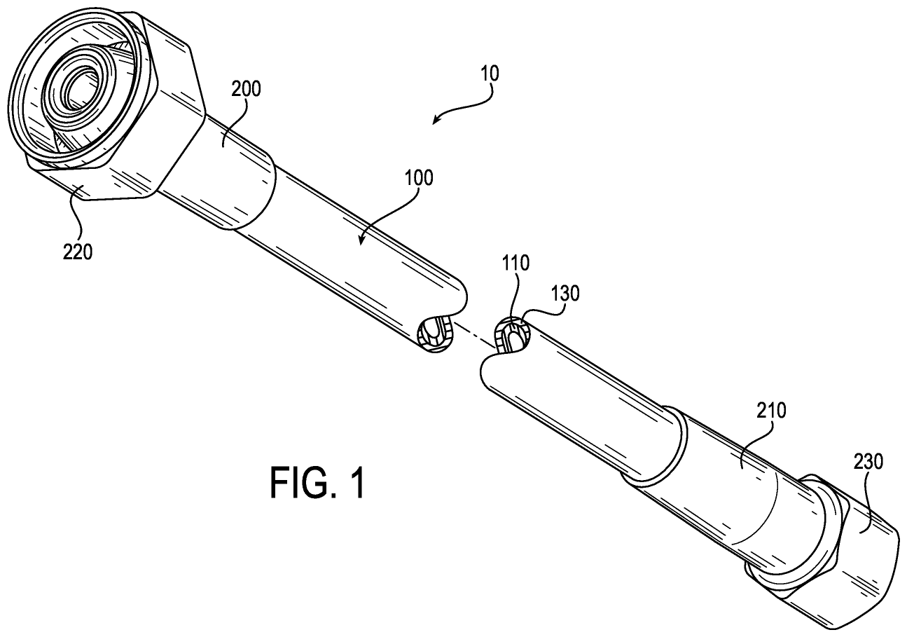

In one embodiment, a multilayer flexible riser 10 is shown in FIG. 1. Riser 10 includes a multilayer tube 100 including an inner layer 110 and an outer layer 130. Riser 100 also includes overmolded components 200, 210 on the ends of the riser. Nuts 220, 230 are located at the ends of the riser around the overmolded components 200, 210 for securing to a shutoff or “stop” valve on one end and a plumbing hook-up on the other end.

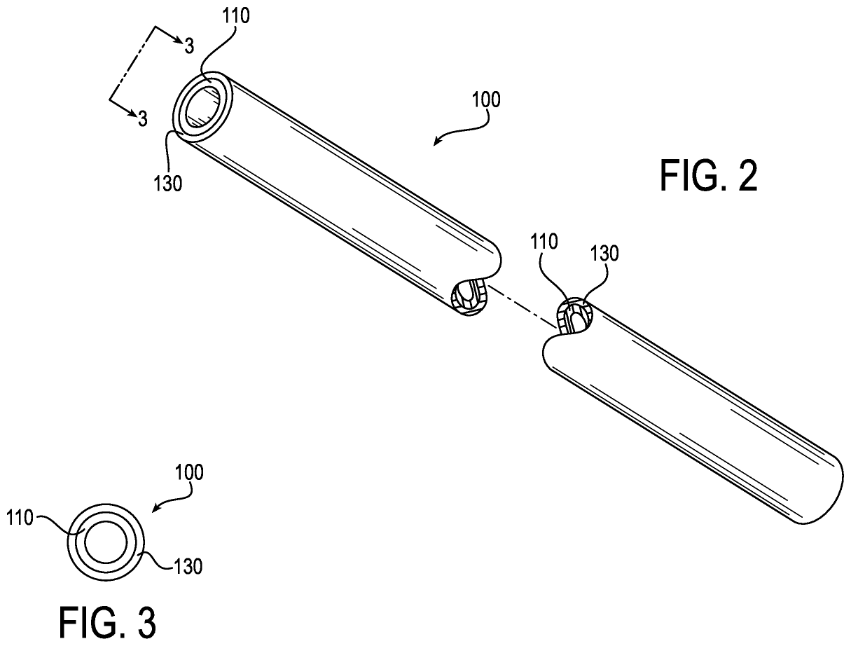

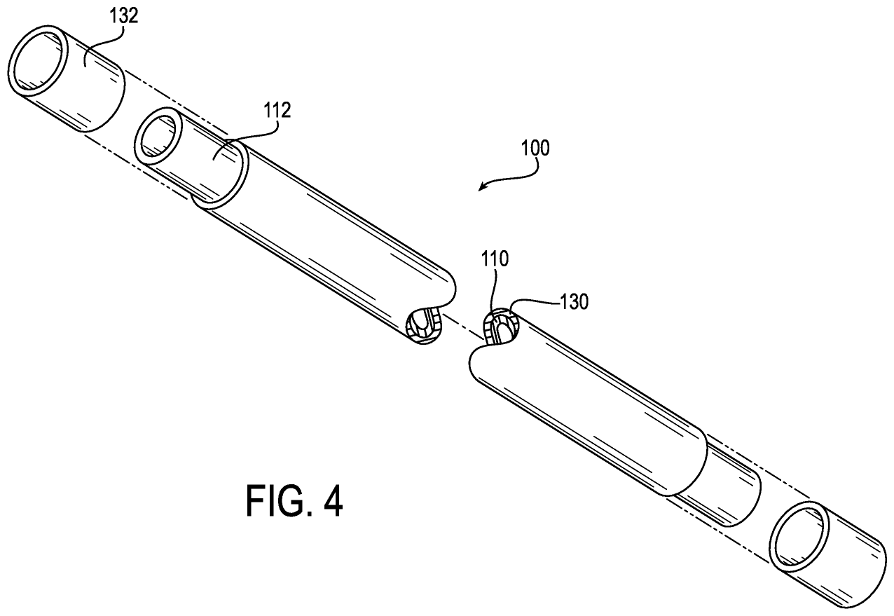

FIG. 2 shows a perspective view of the multilayer tube including the inner layer 110 and the outer layer 130, with an end view shown in FIG. 3. As shown in FIG. 4, in order to promote sufficient material-to-material bonding at end locations of the multilayer tube 100 between an overmolded component and the inner layer 110, a section 132 of the outer layer 130 is removed a sufficient distance along multilayer tube 100 in order to provide a bonding region prior to commencing the overmolding process, thereby insuring leak-proof engagement. This may be accomplished using wire strippers, a blade, knife or some other type of known cutting tool. After cutting, the outer section 132 may be removed by an operator by sliding the outer section 132 off of the inner layer 110 when there is no bond between the inner layer and the outer layer. If there is substantially no bond or minimal adhesion between the outer layer and the inner layer, the outer section 132 of the outer layer 130 may be removed by an operator after cutting by applying force to the outer section by physically pulling the outer section off of the inner layer. This physical force by the operator would break any bonds or minimal adhesion between the section of the outer layer and the inner layer to allow for removal of the section of the outer layer. Alternatively, a machine or other type of automation could be utilized to quickly remove the section of the outer layer.

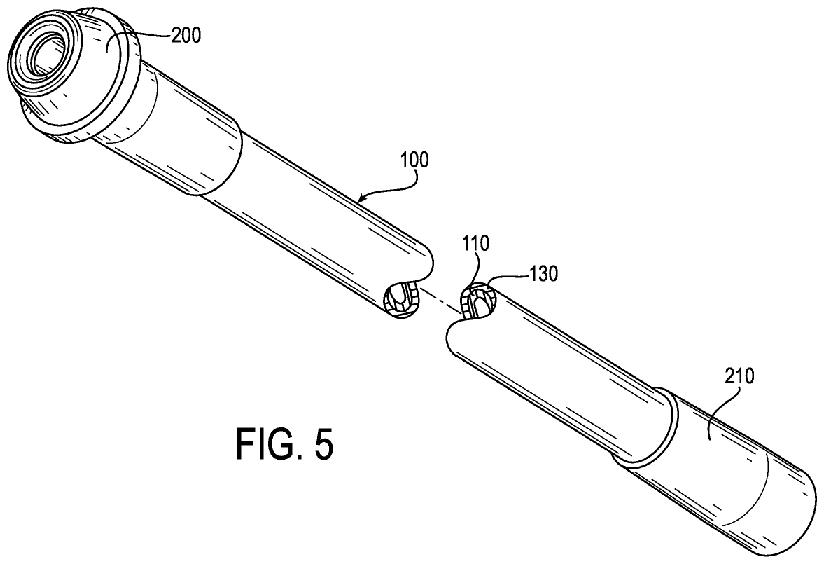

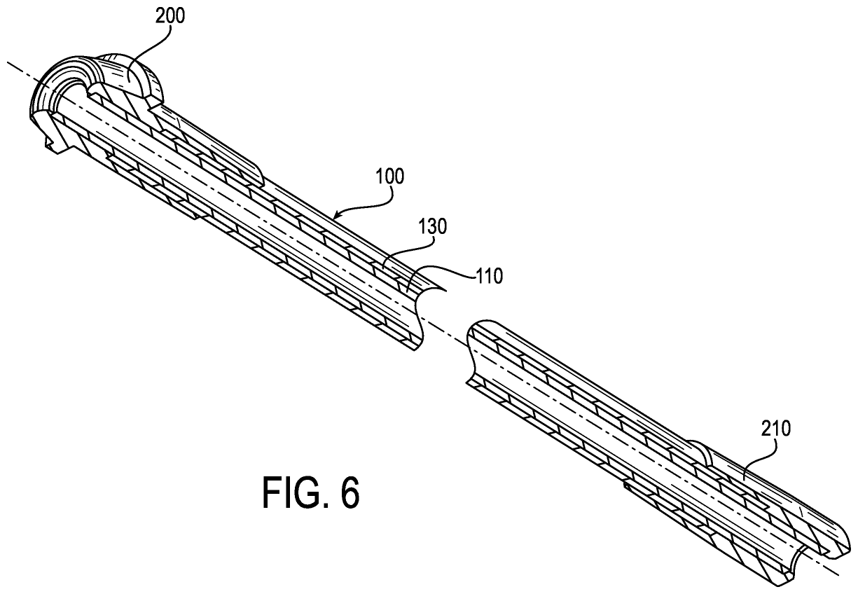

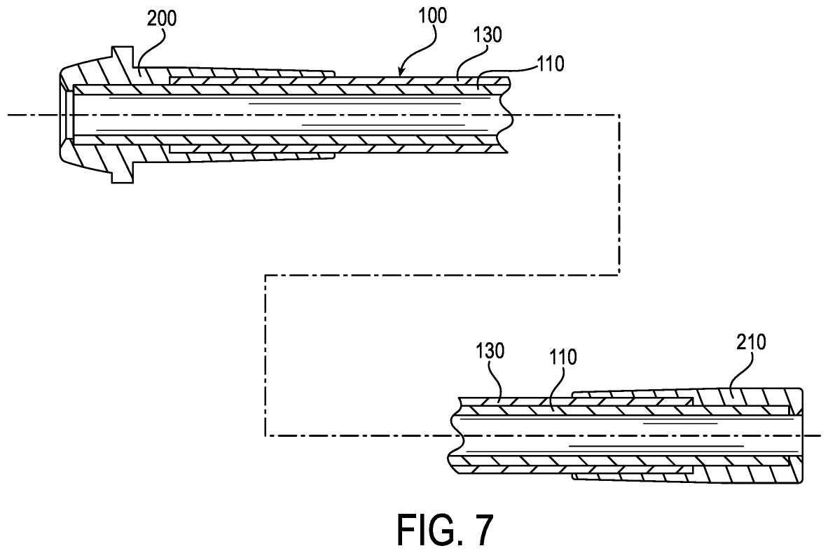

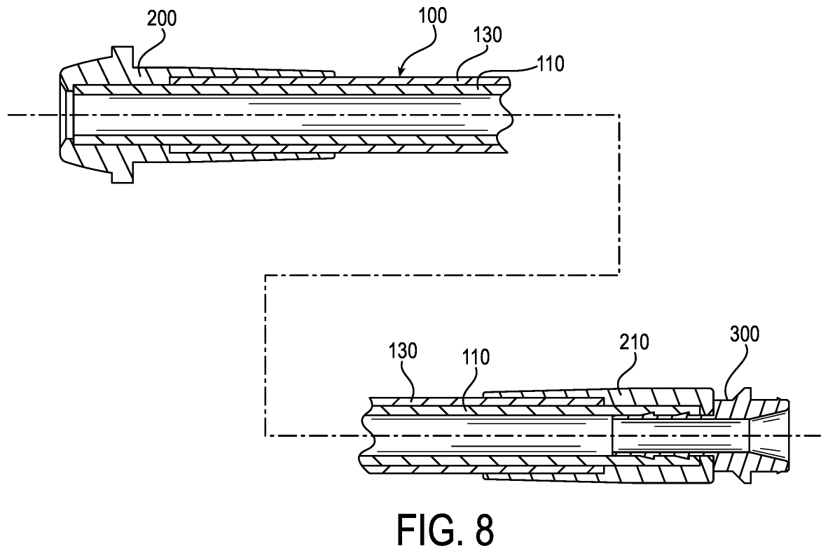

An overmolded component 200, 210 may then be bonded to an exposed section 112 of the inner layer 110 and a section of outer layer 130 adjacent to the exposed section 132 of inner layer 110 to provide a leak-free connection as shown in FIG. 5. FIGS. 6-8 display cross-sectional views of the multilayer tube 100 with the overmolded components 200, 210, as well as a fitting 300 inserted into the overmolded component 210 in FIG. 8. As shown in the figures, the overmolded components 200, 210 are bonded to a section of the inner layer 110 and a section of the outer layer 130 at the ends of the multilayer tube. In an alternative embodiment, the overmolded components may only be bonded to the sections of the inner layer 110 without any bond to the sections of the outer layer 130. In this example, the outer layer “floats” between the respective overmolded components because it is not constrained by the overmolded components, and the outer layer is either not bonded or substantially not bonded to the inner layer.

After the outer section of the outer layer is removed, which may be done on one or both ends of the tube, the outer layer is shorter in length than the inner layer which increases movement between the inner layer and the outer layer. This allows lateral or rotational displacement of the layers relative to each other instead of constraining the movement of the layers in a specific area and localizing deformation strain in that area, thereby increasing the flexibility of the multilayer tube. In yet other embodiments, the outer layer may be isolated on the length of the inner layer and be provided at predetermined bend locations on the inner layer. In some of these embodiments, multiple outer layers may be provided on a single inner layer. Further, the outer layer may be movable, i.e. the outer layer may be moved or relocated to new bend locations when new bend locations are identified or utilized.

In one particular embodiment, the inner layer comprises high density polyethylene (HDPE) and the outer layer comprises thermoplastic urethane (TPU). These materials are incompatible, and thus are not bonded to one another after the coextrusion process. Because of this incompatibility and lack of bonding, the TPU outer layer is moveable with respect to the HDPE inner layer. For example, the TPU outer layer can rotate with respect to and/or slide along the HDPE inner layer due to the lack of bonding. Additionally, the TPU outer layer is easily removeable from the underlying HDPE inner layer. This provides for the underlying HDPE inner layer to be crosslinked independent of the TPU outer layer in various embodiments. In some embodiments, the inner layer may be crosslinked with the outer layer in place about the inner layer. This is accomplished by scoring or cutting the outer layer of the tube to expose the HDPE inner layer in order to subsequently crosslink that respective layer. By example, the tube may be scored by using a wire stripper. By crosslinking the HDPE inner layer, the robustness of a HDPE inner layer with characteristics of crosslinked polyethylene (PEX) is provided. Increased flexibility and support of the more rigid inner layer is provided through the more flexible TPU outer layer. The outer layer may be constructed of different or a composite of materials including ethylene propylene diene terpolymer or EPDM while not departing from the scope of the present invention. By example, EPDM material may further prevent bonding or adhesion between the inner layer and outer layer during the extrusion process, as discussed in greater detail below. Comparatively, bonding or adhesion properties may be manipulated between a PEX inner layer and an EPDM outer layer during a later crosslinking process, as discussed in greater detail below. Similarly, the properties of a TPU layer may also be manipulated to prevent, increase, and/or decrease adhesion or bonding properties during the various manufacturing processes.

Additional additives or ingredients can be added to the polymers of the inner layer and/or outer layer to further increase or decrease certain properties such as rigidity, flexibility, burst resistance, temperature resistance, kink resistance and hoop strength. For example, EVA may be added to high density polyethylene to increase flexibility. Also, the EVA may be serve-braided to add additional strength. Typical polymers referred to herein may include polyethylene, such as linear low density polyethylene, high density polyethylene and PERT (polyethylene of raised temperature). Additionally, the polymers may be crosslinked as further discussed below.

The multilayer tube may further include a braided material surrounding either the inner layer and/or the outer layer. The braided material or braid may comprise polymeric braiding providing additional burst strength, abrasion resistance and cosmetic appeal. In some embodiments metal braiding may additionally or alternatively be provided.

The various combinations of configurations as described above allow modifications to improve the strength, bend characteristics, and performance parameters of both the inner layer and the outer layer of the multilayer tube. In some embodiments, various combinations allow a thinner inner layer. With the support of the outer layer, such a thinner inner layer is supported with increased flexibility while preventing kinking.

The ends of the multilayer tube may be terminated with fittings that can be varied to suit the various application needs. The fittings may be made from metal or plastic. These fittings would typically incorporate a compression system involving a flexible seal (washer) and a nut for attachment. In one embodiment, the fitting is attached to the hose by means of a barb and/or raised surface. The barb and/or raised insert may be pressed into a PEX inner layer and secured by shape memory, as discussed in greater detail below. Additionally and alternatively, the barb may be designed larger than the ID of the inner layer for a press fit. This press fit provides some of the pressure resistance of the multilayer tube and can survive by itself in most household water pressure environments. The use of shape memory from the PEX inner layer and/or the outer layer further grips or contracts these layers around the barb and/or raised surface which creates a leak-free or leak-proof connection. By using plastic fittings as described in this particular embodiment, contact between the water way and metal fittings is eliminated. This eliminates the potential of lead leaching, corrosion, dezincification, and/or the attack of hard water on brass fittings which are all undesirable for potable waterways.

PEX has a unique property called “shape memory” by which it tries to return to its original crosslinked shape and size when stretched or displaced. Shape memory is discussed in greater detail below. Using this shape memory feature permits leak-proof or leak-free engagement of the multilayer tube to the fitting when PEX is expanded and then allowed to contract or return to its original shape. As previously noted, the inner layer and/or the outer layer may use shape memory to contract around the barb and/or raised surface of the fitting after the barb and/or raised surface is inserted into the ID of the inner layer. Essentially, shape memory is imparted onto the end of the hose and fitting to create a leak-free or leak-proof connection.

In one embodiment of this invention, the inner layer polymeric tubing is made from high density polyethylene. After extrusion of the multilayer tube and subsequent overmolding of the overmolded components, the multilayer flexible riser is crosslinked. Crosslinked polyethylene is abbreviated PEX, for “polyethylene, crosslinked.” PEX contains crosslinked bonds in the polymer structure changing the thermoplastic into a thermoset. The outer layer is also crosslinked as part of the multilayer riser. Crosslinking may be accomplished during or after the molding of the part. The required degree of crosslinking for crosslinking polyethylene tubing, according to ASTM Standard F 876-93, is between 65-89%. There are three classifications of PEX, referred to as PEX-A, PEX-B, and PEX-C. PEX-A is made by the peroxide (Engel) method. In the PEX-A method, peroxide blending with the polymer performs crosslinking above the crystal melting temperature. The polymer is typically kept at high temperature and pressure for long periods of time during the extrusion process. PEX-B is formed by the silane method, also referred to as the “moisture cure” method. In the PEX-B method, silane blended with the polymer induces crosslinking during molding and during secondary post-extrusion processes, producing crosslinks between a crosslinking agent. The process is accelerated with heat and moisture. The crosslinked bonds are formed through silanol condensation between two grafted vinyltrimethoxysilane units. PEX-C is produced by application of an electron beam using high energy electrons to split the carbon-hydrogen bonds and facilitate crosslinking.

Crosslinking imparts shape memory properties to polymers. Shape memory materials have the ability to return from a deformed state (e.g. temporary shape) to their original crosslinked shape (e.g. permanent shape), typically induced by an external stimulus or trigger, such as a temperature change. Alternatively or in addition to temperature, shape memory effects can be triggered by an electric field, magnetic field, light, or a change in pH, or even the passage of time. Shape memory polymers include thermoplastic and thermoset (covalently crosslinked) polymeric materials.

Shape memory materials are stimuli-responsive materials. They have the capability of changing their shape upon application of an external stimulus. A change in shape caused by a change in temperature is typically called a thermally induced shape memory effect. The procedure for using shape memory typically involves conventionally processing a polymer to receive its permanent shape, such as by molding the polymer in a desired shape and crosslinking the polymer defining its permanent crosslinked shape. Afterward, the polymer is deformed and the intended temporary shape is fixed. This process is often called programming. The programming process may consist of heating the sample, deforming, and cooling the sample, or drawing the sample at a low temperature. The permanent crosslinked shape is now stored while the sample shows the temporary shape. Heating the shape memory polymer above a transition temperature Tₜᵣₐₙₛ induces the shape memory effect providing internal forces urging the crosslinked polymer toward its permanent or crosslinked shape. Alternatively or in addition to the application of an external stimulus, it is possible to apply an internal stimulus (e.g., the passage of time) to achieve a similar, if not identical result.

A chemical crosslinked network may be formed by low doses of irradiation. Polyethylene chains are oriented upon the application of mechanical stress above the melting temperature of polyethylene crystallites, which can be in the range between 60° C. and 13° C. Materials that are most often used for the production of shape memory linear polymers by ionizing radiation include high density polyethylene, low density polyethylene and copolymers of polyethylene and poly(vinyl acetate). After shaping, for example, by extrusion or compression molding, the polymer is covalently crosslinked by means of ionizing radiation, for example, by highly accelerated electrons. The energy and dose of the radiation are adjusted to the geometry of the sample to reach a sufficiently high degree of crosslinking, and hence sufficient fixation of the permanent shape.

Another example of chemical crosslinking includes heating poly(vinyl chloride) under a vacuum resulting in the elimination of hydrogen chloride in a thermal dehydrocholorination reaction. The material can be subsequently crosslinked in an HCl atmosphere. The polymer network obtained shows a shape memory effect. Yet another example is crosslinked poly[ethylene-co-(vinyl acetate)] produced by treating the radical initiator dicumyl peroxide with linear poly[ethylene-co-(vinyl acetate)] in a thermally induced crosslinking process. Materials with different degrees of crosslinking are obtained depending on the initiator concentration, the crosslinking temperature and the curing time. Covalently crosslinked copolymers made form stearyl acrylate, methacrylate, and N,N′ -methylenebisacrylamide as a crosslinker.

Additionally shape memory polymers include polyurethanes, polyurethanes with ionic or mesogenic components, block copolymers consisting of polyethyleneterephthalate and polyethyleneoxide, block copolymers containing polystyrene and poly(1,4-butadiene), and an ABA triblock copolymer made from poly(2-methyl-2-oxazoline) and a poly(tetrahydrofuran). Further examples include block copolymers made of polyethylene terephthalate and polyethylene oxide, block copolymers made of polystyrene and poly(1,4-butadiene) as well as ABA triblock copolymers made from poly(tetrahydrofuran) and poly(2-methyl-2-oxazoline). Other thermoplastic polymers which exhibit shape memory characteristics include polynorbornene, and polyethylene grated with nylon-6 that has been produced for example, in a reactive blending process of polyethylene with nylon-6 by adding maleic anhydride and dicumyl peroxide.

The terms “comprising,” “including,” and “having,” as used in the claims and specification herein, shall be considered as indicating an open group that may include other elements not specified. The terms “a,” “an,” and the singular form of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things are intended. The terms “preferably,” “preferred,” “prefer,” “optionally,” “may,” and similar terms are used to indicate that an item, condition or step being referred to is an optional (i.e., not required) feature of the invention.

While this invention has been described with reference to particular embodiments thereof, it shall be understood that such description is by way of illustration only and should not be construed as limiting the scope of the claimed invention. Accordingly, the scope and content of the invention are to be defined only by the terms of the following claims. Furthermore, it is understood that the features of any specific embodiment discussed herein may be combined with one or more features of any one or more embodiments otherwise discussed or contemplated herein unless otherwise stated.

1. A multilayer tube comprising:
a first inner polymer layer and a second outer polymer layer,
wherein the first inner polymer layer and second outer polymer layer are not substantially bonded to each other.

2. The multilayer tube according to claim 1, additionally comprising at least one overmolded component, wherein the overmolded component is a connector.

3. The multilayer tube according to claim 2, wherein the connector is a potable water connector.

4. The multilayer tube according to claim 1, wherein the inner polymer layer is adapted to withstand 250 psi at 180° F. for 30 minutes.

5. The multilayer tube according to claim 4, wherein 150 pound force (lbf) or less is necessary to separate the inner and outer layers.

6. The multilayer tube according to claim 5, wherein 100 pound force (lbf) or less is necessary to separate the inner and outer layers.

7. The multilayer tube according to claim 6, wherein 70 pound force (lbf) or less is necessary to separate the inner and outer layers.

8. The multilayer tube according to claim 1, wherein the inner polymer layer comprises a polyethylene polymer.

9. The multilayer tube according to claim 8, wherein the inner polymer layer comprises a crosslinked polyethylene polymer.

10. The multilayer tube according to claim 8, wherein the inner polymer layer comprises a high density polyethylene polymer.

11. The multilayer tube according to claim 8, wherein the outer polymer layer comprises a flexible polymer.

12.-20. (canceled)

21. A multilayer tube comprising:
a first inner polymer layer and a second outer polymer layer, wherein the first inner polymer layer and second outer polymer layer are not substantially bonded to each other;
at least one overmolded component, wherein the overmolded component is a connector;
wherein the first inner polymer layer is adapted to withstand 250 psi at 180° F. for 30 minutes; and
wherein the first inner polymer layer comprises a polyethylene polymer.

22. The multilayer tube according to claim 21, wherein the connector is a potable water connector.

23. The multilayer tube according to claim 21, wherein 150 pound force (lbf) or less is necessary to separate the inner and outer layers.

24. The multilayer tube according to claim 23, wherein 100 pound force (lbf) or less is necessary to separate the inner and outer layers.

25. The multilayer tube according to claim 24, wherein 70 pound force (lbf) or less is necessary to separate the inner and outer layers.

26. The multilayer tube according to claim 21, wherein the inner polymer layer comprises a crosslinked polyethylene polymer.

27. The multilayer tube according to claim 21, wherein the inner polymer layer comprises a high density polyethylene polymer.

28. The multilayer tube according to claim 21, wherein the outer polymer layer comprises a flexible polymer.
